(19) United States
(12) Patent Application Publication
(10) Pub. No.: US 2025/0239961 A1
(43) Pub. Date: Jul. 24, 2025

(54) Portable Tent Device with Electrical Power Supply

(71) Applicants: Bruce Baum, Norwalk, CA (US); Phillip Baum, Santa Fe Springs, CA (US)

(72) Inventors: Bruce Baum, Norwalk, CA (US); Phillip Baum, Santa Fe Springs, CA (US)

(21) Appl. No.: 18/754,256

(22) Filed: Jun. 26, 2024

Related U.S. Application Data
(60) Provisional application No. 63/622,260, filed on Jan. 18, 2024.

(51) Int. Cl. H02S 10/40; E04H 15/02; E04H 15/54; E04H 15/60

(52) U.S. Cl. CPC H02S 10/40; E04H 15/02; E04H 15/54; E04H 15/60

(57) ABSTRACT

A portable tent device with electrical power supply is provided. The device is comprised of a frame including at least one vertical frame member and one horizontal frame member. The vertical frame member may include a foot that can be repositioned or adjusted in angle and features an opening for securing the device with a fastener like a ground stake. Additionally, the device incorporates a roof comprised of at least one solar panel that powers an integrated battery. This battery supplies energy to a power outlet that may be positioned on the vertical frame member, to enable the connection and operation of various electrical devices. The device may also include a side wall, connectable to the frame via various fasteners, that is also equipped with additional solar panels that contribute to the power supply, enhancing the device's functionality in providing shade and weather protection.

### CROSS-REFERENCE TO RELATED APPLICATION

The present application claims priority to, and the benefit of, U.S. Provisional Application No. 63/622,260, which was filed on Jan. 18, 2024, and is incorporated herein by reference in its entirety.

### FIELD OF THE INVENTION

The present invention relates generally to the field of tents. More specifically, the present invention relates to a portable tent device with electric power supply that is comprised of a tent with a roof comprised of at least one solar panel that supplies electrical power to at least one power outlet on the frame of the device. Accordingly, the present disclosure makes specific reference thereto. Nonetheless, it is to be appreciated that aspects of the present invention are also equally applicable to other like applications, devices, and methods of manufacture.

### BACKGROUND

Experiencing electricity shortages due to power outages, natural disasters, geographical remoteness, and other unpredictable circumstances can lead to significant frustration and inconvenience. For individuals working in outdoor environments, the absence of readily accessible power outlets can severely hinder their ability to perform tasks effectively, particularly when these tasks depend on the use of power tools. This is a common issue on construction sites where electricity infrastructure may not yet be established, leaving workers unable to perform their duties efficiently. Moreover, in such challenging situations, there is often an additional need for shade and protection from the elements, which can include extreme sunlight, wind, and rain. This combination of power scarcity and harsh environmental conditions can complicate the completion of work, affecting productivity and safety.

Therefore, there exists a long-felt need in the art for a device that provides electrical power. There also exists a long-felt need in the art for a portable tent device with electrical power supply. More specifically, there exists a long-felt need in the art for a portable tent device with electrical power supply wherein the device provides a portable electrical power supply. In addition, there exists a long-felt need in the art for a portable tent device with electrical power supply wherein the device provides a portable electrical power supply and wherein the device also provides protection from the elements.

The subject matter disclosed and claimed herein, in one embodiment thereof, comprises a portable tent device with electrical power supply. The device is comprised of a frame including at least one vertical frame member and one horizontal frame member. The vertical frame member may include a foot that can be repositioned or adjusted in angle and features an opening for securing the device with a fastener like a ground stake. Additionally, the device incorporates a roof comprised of at least one solar panel that powers an integrated battery. This battery supplies energy to a power outlet that may be positioned on the vertical frame member, to enable the connection and operation of various electrical devices. The device may also include a side wall, connectable to the frame via various fasteners, that is also equipped with additional solar panels that contribute to the power supply, enhancing the device's functionality in providing shade and weather protection.

In this manner, the portable tent device with electrical power supply of the present invention accomplishes all the forgoing objectives and provides a device that provides electrical power. More specifically, the device provides a portable electrical power supply charged via solar power. In addition, the device also simultaneously provides protection from the elements in the form of a tent.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable tent device with electrical power supply. The device is comprised of a frame comprised of at least one vertical frame member and at least one horizontal frame member. The vertical member may be comprised of at least one foot. In one embodiment, the foot is comprised of at least one opening that allows at least one fastener to be driven through the foot and into the ground surface to secure the device to a ground surface.

The device is also comprised of at least one roof. The roof preferably fixedly or removably attaches to the vertical frame member and the horizontal frame member. The roof is comprised of at least one solar panel that may be positioned anywhere on the roof surface. The solar panel provides an electric charge to at least one battery of the device. The battery then provides power to at least one female power outlet, preferably positioned on the vertical frame member. The outlet allows various items to be plugged into and powered by the battery while the roof provides shade and protection from weather.

In one embodiment, the device is comprised of at least one side wall that preferably attaches between two vertical frame members and may also attach to the horizontal frame member between the two vertical frame members. The side wall may be made from the same material as the roof and may also be comprised of at least one solar panel that provides power to the battery. The side wall may removably attach to the frame members.

Accordingly, the portable tent device with electrical power supply of the present invention is particularly advantageous as it provides a device that provides electrical power. More specifically, the device provides a portable electrical power supply charged via solar power. In addition, the device also simultaneously provides protection from the elements in the form of a tent. In this manner, the portable tent device with electrical power supply provides a solution to accessing electrical power and outlets while also receiving protection from weather elements.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a portable tent device with electrical power supply of the present invention with no side walls in accordance with the disclosed architecture; and

FIG. 2 illustrates a perspective view of one potential embodiment of a portable tent device with electrical power supply of the present invention with side walls in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that provides electrical power. There also exists a long-felt need in the art for a portable tent device with electrical power supply. More specifically, there exists a long-felt need in the art for a portable tent device with electrical power supply wherein the device provides a portable electrical power supply. In addition, there exists a long-felt need in the art for a portable tent device with electrical power supply wherein the device provides a portable electrical power supply and wherein the device also provides protection from the elements.

The present invention, in one exemplary embodiment, is comprised of a portable tent device with electrical power supply comprised of a frame comprised of at least one vertical frame member and at least one horizontal frame member. The vertical member may be comprised of at least one foot. In one embodiment, the foot is comprised of at least one opening that allows at least one fastener to be driven through the foot and into the ground surface to secure the device to a ground surface.

The device is also comprised of at least one roof that fixedly or removably attaches to the vertical frame member and horizontal frame member. The roof is comprised of at least one solar panel that may be positioned anywhere on the roof surface. The solar panel provides an electric charge to at least one battery of the device. The battery then provides power to at least one female power outlet, preferably positioned on the vertical frame member. The outlet allows various items to be plugged into and powered by the battery while the roof provides shade and protection from weather.

In one embodiment, the device is comprised of at least one side wall that preferably attaches between two vertical frame members and may also attach to the horizontal frame member between the two vertical frame members. The side wall may be made from the same material as the roof and may also be comprised of at least one solar panel that provides power to the battery. The side wall may removably attach to the frame members.

Accordingly, the portable tent device with electrical power supply of the present invention is particularly advantageous as it provides a device that provides electrical power. More specifically, the device provides a portable electrical power supply charged via solar power. In addition, the device also simultaneously provides protection from the elements in the form of a tent. In this manner, the portable tent device with electrical power supply provides a solution to accessing electrical power and outlets while also receiving protection from weather elements.

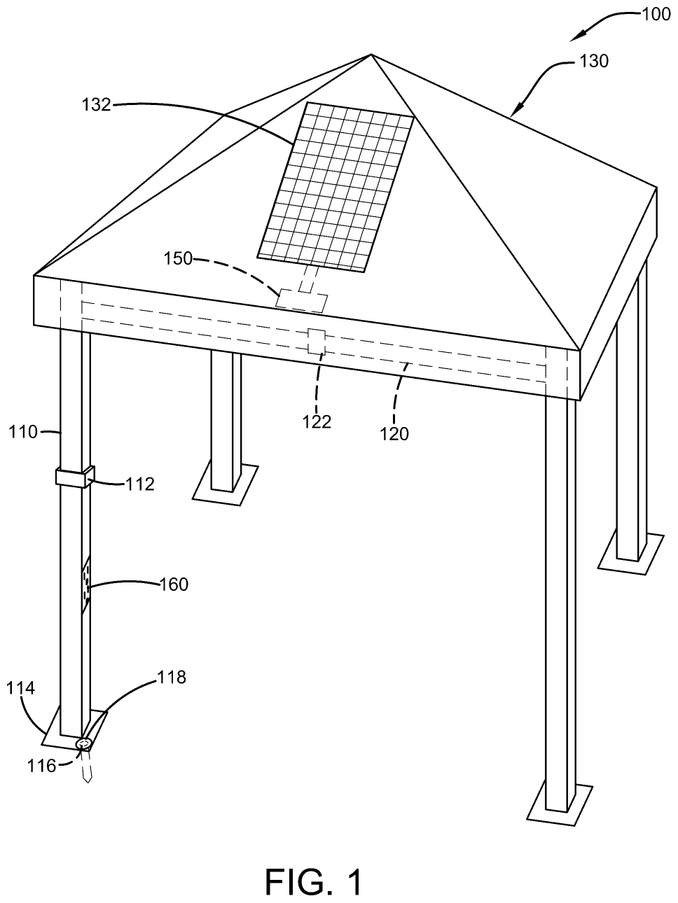

Referring initially to the drawings, FIG. 1 illustrates a perspective view of one potential embodiment of a portable tent device with electrical power supply 100 of the present invention with no side walls in accordance with the disclosed architecture. The device 100 is comprised of a frame comprised of at least one vertical frame member 110 and at least one horizontal frame member 120. The frame members 110,120 may be any size, shape, and configuration and may be made from any material in different embodiments. In one embodiment, both members 110,120 are telescopic/collapsible for storage/transport purposes. In this embodiment, each member 120,130 can be secured at a desired length via at least one locking member 112,122 such as but not limited to a locking button, a locking clip, a locking clamp, etc.

The vertical member 110 may be comprised of at least one foot 114. The foot 114 may be any size, shape, and configuration of foot known in art. In one embodiment, the foot 114 is repositionable/angle adjustable. In a further embodiment, the foot 114 is comprised of at least one opening 116 that allows at least one fastener 118, such as but not limited to a ground stake, to be driven through the foot 114 and into the ground surface to secure the device 100 to a ground surface.

The device 100 is also comprised of at least one roof 130. The roof 130 and frame members 110,120 may form a structure of any size, shape, and dimension. The roof 130 preferably fixedly or removably attaches to the vertical frame member 110 and horizontal frame member 120. The roof 130 may be made of a plurality of materials in different embodiments. In one embodiment, the roof 130 is made from a rigid material such as but not limited to metal, plastic, etc. In another embodiment, the roof 130 is made from a waterproof fabric material. The roof 130 is comprised of at least one solar panel 132 that may be positioned anywhere on the roof 130 surface. The solar panel 132 may be any type of solar panel such as but not limited to a monocrystalline solar panel, a polycrystalline solar panel, a film solar panel, etc.

The solar panel 132 provides an electric charge to at least one battery 150 of the device 100. The battery 150 may be any tyle and style of battery. The battery 150 then provides power to at least one female power outlet 160, preferably positioned on the vertical frame member 110. However, the outlet 160 may be positioned anywhere on the frame member 110 and/or device 100. The outlet 160 may be any style of power outlet but is preferably a 110v/120v outlet. The outlet 160 allows various items to be plugged into and powered by the battery 150 while the roof 130 provides shade and protection from weather.

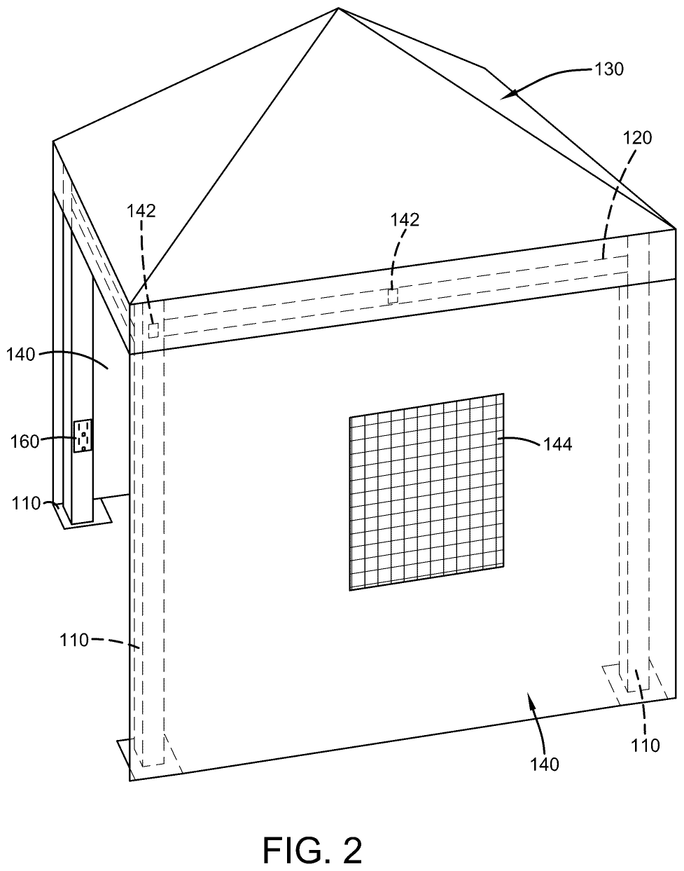

In one embodiment, the device 100 is comprised of at least one side wall 140, as seen in FIG. 2. The side wall 140 preferably attaches between two vertical frame members 110 and may also attach to the horizontal frame member 120 between the two vertical frame members 110. The side wall 140 may be made from the same material as the roof 130 and may also be comprised of at least one solar panel 144 that provides power to the battery 150. The side wall 140 may removably attach to the frame members 110,120 (as described above) via at least one fastener 142 such as but not limited to a clip, a clamp, a magnet, a tongue, a groove, etc.

In one embodiment, the vertical member 110 is a ground umbrella frame member, wherein the roof 130 is comprised of an umbrella body shape.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable tent device with electrical power supply” and “device” are interchangeable and refer to the portable tent device with electrical power supply 100 of the present invention.

Notwithstanding the forgoing, the portable tent device with electrical power supply 100 of the present invention and its various components can be of any suitable size and configuration as is known in the art without affecting the overall concept of the invention, provided that they accomplish the above-stated objectives. One of ordinary skill in the art will appreciate that the size, configuration, and material of the portable tent device with electrical power supply 100 as shown in the FIGS. are for illustrative purposes only, and that many other sizes and shapes of the portable tent device with electrical power supply 100 are well within the scope of the present disclosure. Although the dimensions of the portable tent device with electrical power supply 100 are important design parameters for user convenience, the portable tent device with electrical power supply 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable tent device with electrical power supply comprising:
a vertical frame member;
a horizontal frame member;
a roof comprised of a solar panel;
a battery; and
an outlet.

2. The portable tent device with electrical power supply of claim 1, wherein the vertical frame member is telescopic.

3. The portable tent device with electrical power supply of claim 1, wherein the horizontal frame member is telescopic.

4. The portable tent device with electrical power supply of claim 1, wherein the vertical frame member is comprised of a foot.

5. The portable tent device with electrical power supply of claim 4, wherein the foot is comprised of an opening.

6. The portable tent device with electrical power supply of claim 1, wherein the roof is comprised of a waterproof fabric material.

7. The portable tent device with electrical power supply of claim 1, wherein the solar panel is comprised of a monocrystalline solar panel, a polycrystalline solar panel, or a film solar panel.

8. The portable tent device with electrical power supply of claim 1, wherein the outlet is positioned on the horizontal frame member.

9. The portable tent device with electrical power supply of claim 1, wherein the outlet is comprised of a 110v or a 120v outlet.

10. A portable tent device with electrical power supply comprising:
a vertical frame member;
a horizontal frame member;
a roof comprised of a solar panel;
a battery; and
an outlet positioned on the vertical frame member.

11. The portable tent device with electrical power supply of claim 10, wherein the roof is comprised of a rigid material.

12. The portable tent device with electrical power supply of claim 10, wherein the solar panel is comprised of a monocrystalline solar panel, a polycrystalline solar panel, or a film solar panel.

13. The portable tent device with electrical power supply of claim 10, wherein the outlet is comprised of a 110v or a 120v outlet.

14. A portable tent device with electrical power supply comprising:
a vertical frame member;
a horizontal frame member;
a roof comprised of a first solar panel;
a battery;
an outlet; and
a side wall comprised of a second solar panel.

15. The portable tent device with electrical power supply of claim 14, wherein the side wall attaches to the vertical frame member via a first fastener.

16. The portable tent device with electrical power supply of claim 14, wherein the first fastener is comprised of a clip, a clamp, a magnet, a tongue, or a groove.

17. The portable tent device with electrical power supply of claim 14, wherein the side wall attaches to the horizontal frame member via a second fastener.

18. The portable tent device with electrical power supply of claim 14, wherein the second fastener is comprised of a clip, a clamp, a magnet, a tongue, or a groove.

19. The portable tent device with electrical power supply of claim 14, wherein the side wall is comprised of a waterproof fabric material.

20. The portable tent device with electrical power supply of claim 14, wherein the side wall is comprised of a rigid material.
